(19) United States
(12) Patent Application Publication
(10) Pub. No.: US 2025/0091939 A1
(43) Pub. Date: Mar. 20, 2025

(54) Fluorescent Glasses And Glass Ceramics With High Content Of Cerium And Tin

(71) Applicant: Ivoclar Vivadent AG, Schaan (LI)

(72) Inventors: Marc Dittmer, Feldkirch (AT); Markus Rampf, Seewis Dorf (CH); Christian Ritzberger, Grabs (CH)

(21) Appl. No.: 18/890,572

(22) Filed: Sep. 19, 2024

(30) Foreign Application Priority Data
Sep. 20, 2023 (EP) 23198551.6

(51) Int. Cl. C03C 10/00; C03C 3/078; C03C 4/00; C03C 4/12

(52) U.S. Cl. CPC C03C 10/0054; C03C 3/078; C03C 4/0021; C03C 4/12; C03C 10/0009

(57) ABSTRACT

Glasses and glass ceramics with high content of cerium and tin, which include the following components:

| Component | Wt. % |
|---|---|
| SiO₂ | 48.0 to 75.0 |
| Li₂O | 8.0 to 20.5 |
| Cerium, calculated as CeO₂ | 4.0 to 20.0 |
| Tin, calculated as SnO | 3.1 to 15.7 |

and which are particularly suitable for the preparation of dental restorations with fluorescence properties largely corresponding to those of natural teeth.

### CROSS-REFERENCE TO RELATED APPLICATIONS

This application claims priority to European Patent Application No. 23198551.6 filed on Sep. 20, 2023, the disclosure of which is incorporated herein by reference in its entirety.

### TECHNICAL FIELD

The present invention relates to glasses and glass ceramics which have a high content of cerium and tin and are particularly suitable for the production of dental restorations whose fluorescence properties largely correspond to those of natural teeth. The invention also relates to a process for preparing the glasses and glass ceramics according to the invention and their use as an admixing component and as a dental material, in particular for preparing of dental restorations.

### BACKGROUND

Glass ceramics are used in dentistry due to their good mechanical and optical properties, especially for the production of dental crowns and small bridges.

WO 2017/032745 A1 and corresponding U.S. Ser. No. 10/501,366 B2, which US patent is incorporated by reference in its entirety, describe lithium silicate low quartz glass ceramics for use in dentistry. The glass ceramics may contain colorants and fluorescent agents preferably selected from Bi₂O₃ and Bi₂O₅ and inorganic pigments and/or oxides of d and f elements, such as the oxides of Mn, Fe, Co, Pr, Nd, Tb, Er, Dy, Eu and Yb.

From EP 3 696 150 A1 and corresponding U.S. Ser. No. 11/440,834 B2, which US patent is incorporated by reference in its entirety, glasses and glass ceramics are known which contain 0.05 to 5.0 wt.-% europium, calculated as Eu₂O₃, to impart advantageous fluorescence properties to dental restorations made from the glasses and glass ceramics.

From W. Buchalla, “Comparative Fluorescence Spectroscopy Shows Differences in Non-Cavitated Enamel Lesions,” Caries Res. 2005, 39, 150-156, it is known that natural teeth show bluish-white fluorescence under ultraviolet light with wavelengths ranging from 400 to 650 nm.

Rukmani et al, J. Am. Ceram. Soc. 2007, 90, 706-711, describe the influence of V and Mn colorants on the crystallization behavior and optical properties of Ce-doped lithium disilicate glass ceramics. To prepare the glass ceramics, a mixture of the starting materials SiO₂, ZrO₂, Li₂CO₃, K₂CO₃, MgCO₃ and Al(PO₃)₃ with CeO₂, V₂O₅ and MnO₂ is prepared, the mixture is melted at 1500° C. in platinum crucibles, cooled and then subjected to several heat treatments in a tube furnace under air supply.

EP 3 696 149 A1 and corresponding U.S. Ser. No. 11/440,833 B2, which US patent is incorporated by reference in its entirety, describe glasses and glass ceramics containing cerium and tin, which fluoresce when excited with light of a wavelength of 366 nm. However, when excited with light of a wavelength of 395 nm, the glasses and glass ceramics described do not show any fluorescence.

It has been shown that the glasses and glass ceramics known from the prior art have insufficient fluorescence properties and cannot sufficiently imitate the fluorescence properties of the natural tooth material, especially under light with a wavelength of about 380 to 430 nm. In particular, there is a need for glasses and glass ceramics that also exhibit good fluorescence properties in the particularly long-wave UV range, such as 380 to 430 nm. Light of these wavelengths is often used as “black light” in entertainment venues such as nightclubs. There, therefore, dental restorations with insufficient fluorescence properties may be recognizable as restorations under the influence of long-wave UV light or may be perceived as tooth gaps or defects.

### SUMMARY

The invention is based on the problem of providing glasses and glass ceramics which exhibit fluorescence comparable to that of natural dental material and are thus particularly suitable for the preparation of dental restorations which not only exhibit good mechanical properties but can also largely imitate the fluorescence properties of natural dental material at excitation wavelengths in the long-wave UV range, such as 380 to 430 nm. The glasses and glass ceramics should also be suitable as mixing components for adjusting the fluorescence properties of other glasses and glass ceramics.

This problem is solved according to the invention by glasses and glass ceramics containing cerium and tin as well as the uses of these glasses and glass ceramics. The invention is also directed to a process for preparing the glasses and glass ceramics of the invention as well as a process for preparing a dental restoration.

### BRIEF DESCRIPTION OF THE DRAWINGS

Exemplary embodiments of the invention are shown in the drawings and are described in more detail below, in which:

FIG. 1 shows a comparison of a glass frit and a glass sheet.

FIG. 2 shows a comparison of a non-fluorescent solid glass sheet and a fluorescent glass ceramic blank.

FIG. 3 shows a comparison of a non-fluorescent solid glass sheet and a fluorescent glass ceramic blank.

### DETAILED DESCRIPTION

The invention relates to a glass and a glass ceramic containing cerium and tin, characterized in that they comprise the following components.

| Component | Wt.- % |
|---|---|
| SiO₂ | 48.0 to 75.0 |
| Li₂O | 8.0 to 20.5 |
| Cerium, calculated as CeO₂ | 4.0 to 20.0 |
| Tin, calculated as SnO | 3.1 to 15.7. |

Surprisingly, it has been shown that the glass and glass ceramic according to the invention exhibit improved fluorescence properties compared to the prior art, particularly when exposed to UV light having a wavelength of 380 to 430 nm, such as 395 nm. It has been found in the context of the present invention that the use of higher levels of cerium and tin than known in the prior art causes the fluorescence properties of glasses and glass ceramics to change. In particular, it has been shown that by using higher proportions of cerium and tin, clearly visible fluorescence can be obtained even at excitation wavelengths in the range of 380 to 430 nm. The glasses and glass ceramics according to the invention have therefore proven to be particularly suitable for imitating natural tooth material.

Without limitation to any particular theory, it is assumed that the use of larger amounts of cerium and tin changes the fluorescence properties of Ce³⁺ ions and shifts the excitation spectrum, so that clear fluorescence can also be perceived in glasses and glass ceramics when excited with light of a wavelength in the range of 380 to 430 nm, such as 395 nm.

According to the invention, it is preferred that the glass and the glass ceramic contain 50.0 to 72.0, in particular 52.0 to 70.1 wt.-% and particularly preferably 57.0 to 70.1 SiO₂.

It is further preferred that the glass and glass ceramic contain 9.0 to 19.0, in particular 10.1 to 18.2, and particularly preferably 10.9 to 17.3 wt.-% Li₂O.

Preferably, the glass and the glass ceramic contain 4.3 to 19.0, in particular 4.7 to 18.5, more preferably 5.3 to 17.9, especially preferably 5.8 to 16.6 and most preferably 6.1 to 16.0 wt.-% cerium, calculated as CeO₂.

It is further preferred that the glass and the glass ceramic contain 3.4 to 14.9, in particular 3.7 to 14.5, more preferably 4.1 to 14.0, especially preferably 4.6 to 13.0 and even more preferably 4.7 to 12.6 wt.-% tin, calculated as SnO.

It is also preferred that the molar ratio of cerium, calculated as CeO₂, to tin, calculated as SnO, is in the range of 1.5:1 to 1:1.5, in particular 1.2:1 to 1:1.2 and more preferably 1.1:1 to 1:1.1 and is particularly preferably 1.0:1.0.

In another preferred embodiment, the glass and the glass ceramic include.

| Component | Wt.-% |
|---|---|
| SiO₂ | 50.0to 72.0 wt. %, |
| Li₂O | 9.0to 19.0 wt. %, |
| Cerium, calculated as CeO₂ | 4.3to 19.0 wt. % and |
| Tin, calculated as SnO | 3.4to 14.9 wt. % and in particular |
| SiO₂ | 52.0to 70.1 wt. %, |
| Li₂O | 10.1to 18.2 wt. %, |
| Cerium, calculated as CeO₂ | 4.7to 18.5 wt. % and |
| Tin, calculated as SnO | 3.7to 14.5 wt. % and especially preferred |
| SiO₂ | 52.0to 70.1 wt. %, |
| Li₂O | 10.1to 18.2 wt. %, |
| Cerium, calculated as CeO₂ | 5.3to 17.9 wt. % and |
| Tin, calculated as SnO | 4.1to 14.0 wt. %. |

In a particular embodiment, the glass and the glass ceramic further comprise terbium. Preferably, the glass and the glass ceramic contain 0 to 3.5, in particular 0 to 2.6 and especially preferably 0.1 to 2.6 wt. % terbium, calculated as Tb₄O₇.

It is also preferred that the glass and the glass ceramic contain further alkali metal oxide Me^{I}₂O in an amount of 0 to 11.5, in particular 1.0 to 10.5, further preferred 2.0 to 9.3 and particularly preferred 2.0 to 6.0 wt. %. The term “further alkali metal oxide Me^{I}₂O” means alkali metal oxide with the exception of Li₂O, this Me^{I}₂O being selected in particular from Na₂O, K₂O, Rb₂O and/or Cs₂O and preferably being selected from Na₂O and/or K₂O.

It is further preferred that the glass and glass ceramic contain 0 to 11.0 wt.-%, in particular 0 to 9.3, more preferably 1.0 to 8.0, and especially preferably 2.5 to 5.0 wt.-% K₂O.

Furthermore, it is preferred that the glass and the glass ceramic contain 0 to 11.0, in particular 1.0 to 10.0 and especially preferably 2.0 to 8.0 wt. % of further oxide of divalent elements Me^{II}O. The term “further oxide of divalent elements Me^{II}O” means divalent oxides with the exception of SnO, this Me^{II}O being selected in particular from MgO, CaO, SrO, BaO and/or ZnO. Particularly preferably, the glass and the glass ceramic contain at least one and in particular all of the following oxides of divalent elements Me^{II}O in the amounts indicated:

| Component | Wt.-% |
|---|---|
| MgO | 0 to 2.0 |
| CaO | 0 to 2.5 |
| SrO | 0 to 4.0 |
| ZnO | 0 to 2.2 |

Furthermore, it is preferred that the glass and the glass ceramic contain 0 to 3.0 and in particular 0 to 1.0 wt. % BaO and are particularly preferred substantially free of BaO.

It is also preferred that the glass and glass ceramic contain 0 to 2.0, in particular 0 to 1.5, more preferably 0 to 1.0, and especially preferably 0.1 to 1.0 wt.-% MgO.

In another preferred embodiment, the glass and the glass ceramic contain 0 to 2.5, in particular 0 to 1.8, more preferably 0 to 1.4, and especially preferably 0.1 to 1.4 wt.-% CaO.

Furthermore, it is preferred that the glass and the glass ceramic contain 0 to 3.0, more preferably 0 to 2.8, in particular 0 to 2.5 and especially preferably 0.1 to 2.5 wt.-% SrO.

In a preferred embodiment, the glass and the glass ceramic contain 0 to 2.2, in particular 0 to 1.7, more preferably 0 to 1.3 and especially preferably 0.1 to 1.3 wt.-% ZnO.

A glass and a glass ceramic are further preferred which contain 0 to 8.0, in particular 0 to 7.0 and particularly preferably 2.0 to 6.8 wt.-% further oxide of trivalent elements Me^{III}₂O₃. The term “further oxide of trivalent elements Me^{III}₂O₃” means trivalent oxides with the exception of Ce₂O₃, wherein this Me^{III}₂O₃ is selected in particular from Al₂O₃, B₂O₃, Y₂O₃, La₂O₃, Dy₂O₃, Ga₂O₃ and/or In₂O₃ and is preferably selected from Al₂O₃, B₂O₃, Y₂O₃ and/or La₂O₃.

In a preferred embodiment, the glass and glass ceramic further comprise 0 to 8.0, more preferably 0 to 6.8, further preferably 1.0 to 6.0, and particularly preferably 2.0 to 4.0 wt.-% Al₂O₃.

Furthermore, the glass and the glass ceramic may contain further oxide of tetravalent elements Me^{IV}O₂ in an amount of 0 to 2.0, preferably 0 to 1.5, in particular 0 to 1.0 and preferably 0.1 to 1.0 wt.-%. The term “further oxide of tetravalent elements Me^{IV}O₂” means tetravalent oxides with the exception of SiO₂, CeO₂ and SnO₂, this Me^{IV}O₂ being selected in particular from ZrO₂, TiO₂ and/or GeO₂.

It is also preferred that the glass and the glass ceramic contain 0 to 2.0, in particular 0 to 1.5, more preferably 0 to 1.0 and especially preferably 0.1 to 1.0 wt.-% ZrO₂.

In a preferred embodiment, the glass and the glass ceramic further comprise oxide of pentavalent elements Me^{V}₂O₅ in an amount of 0 to 8.0, in particular 0 to 7.0, preferably 1.0 to 7.0, more preferably 2.0 to 6.8 and particularly preferably 3.0 to 6.5 wt.-%, this Me^{V}₂O₅ being selected in particular from P₂O₅, V₂O₅, Ta₂O₅ and/or Nb₂O₅ and particularly preferably from P₂O₅ and/or Ta₂O₅. In this context, P₂O₅ can act in particular as a nucleating agent. However, the presence of a nucleating agent is not absolutely necessary according to the invention.

Furthermore, it is preferred that the glass and the glass ceramic contain 0 to 8.0, in particular 0 to 7.0, more preferably 0 to 6.8, and especially preferably 1.0 to 6.5 wt. % P₂O₅.

Furthermore, the glass and glass ceramic may contain 0 to 5.0 and, in particular 0 to 2.0 wt.-% fluorine.

Particularly preferred are a glass and a glass ceramic containing at least one, and preferably all, of the following components in the amounts indicated:

| Component | Wt.-% |
|---|---|
| SiO₂ | 48.0 to 75.0 |
| Li₂O | 8.0 to 20.5 |
| Cerium, calculated as CeO₂ | 4.0 to 20.0 |
| Tin, calculated as SnO | 3.1 to 15.7 |
| Me^{I}₂O | 0 to 11.5 |
| Me^{II}O | 0 to 11.0 |
| Me^{III}₂O₃ | 0 to 8.0 |
| Me^{IV}₂O | 0 to 2.0 |
| Me^{V}₂O₅ | 0 to 8.0 |
| Terbium, calculated as Tb₄O₇ | 0 to 3.5 |
| Fluorine | 0 to 5.0, |

wherein Me^{I}₂O, Me^{II}O, Me^{III}₂O₃, Me^{IV}₂O and Me^{V}₂O₅ have in particular the meanings given above.

In another preferred embodiment, the glass and the glass ceramic comprise at least one, and preferably all, of the following components in the amounts indicated:

| Component | Wt.-% |
|---|---|
| SiO₂ | 48.0 to 75.0 |
| Li₂O | 8.0 to 20.5 |
| Cerium, calculated as CeO₂ | 4.0 to 20.0 |
| Tin, calculated as SnO | 3.1 to 15.7 |
| K₂O | 0 to 11.0 |
| Al₂O₃ | 0 to 8.0 |
| MgO | 0 to 2.0 |
| CaO | 0 to 2.5 |
| SrO | 0 to 4.0 |
| ZnO | 0 to 2.2 |
| Terbium, calculated as Tb₄O₇ | 0 to 3.5 |
| P₂O₅ | 0 to 8.0 |
| ZrO₂ | 0 to 2.0 |

In another particularly preferred embodiment, the glass and the glass ceramic comprise at least one, and preferably all, of the following components in the amounts indicated:

| Component | Wt.-% |
|---|---|
| SiO₂ | 52.0 to 70.1 |
| Li₂O | 10.1 to 18.2 |
| Cerium, calculated as CeO₂ | 4.3 to 19.0 |
| Tin, calculated as SnO | 3.4 to 14.9 |
| K₂O | 0 to 9.3 |
| Al₂O₃ | 0 to 6.8 |
| MgO | 0 to 1.0 |
| CaO | 0 to 1.4 |
| SrO | 0 to 2.5 |
| ZnO | 0 to 1.3 |
| Terbium, calculated as Tb₄O₇ | 0 to 2.6 |
| P₂O₅ | 0 to 6.1 |
| ZrO₂ | 0 to 1.0 |

It is still further preferred that the glass and the glass ceramic in this embodiment comprise 4.7 to 18.5 wt.-% cerium, calculated as CeO₂, and 3.7 to 14.5 wt.-% tin, calculated as SnO, in particular 5.3 to 17.9 wt.-% cerium, calculated as CeO₂, and 4.1 to 14.0 wt. % tin, calculated as SnO, more preferably 5.8 to 16.6 wt. % cerium, calculated as CeO₂, and 4.6 to 13.0 wt. % tin, calculated as SnO, and particularly preferably 6.1 to 16.0 wt.-% cerium, calculated as CeO₂, and 4.7 to 12.6 wt.-% tin, calculated as SnO.

The invention also relates to precursors of corresponding composition from which the glass ceramic according to the invention can be produced by heat treatment. These precursors are a correspondingly composed glass (also referred to as starting glass) and a correspondingly composed glass with nuclei. The term “corresponding composition” means that these precursors contain the same components in the same amounts as the glass ceramic, wherein the components, with the exception of fluorine, are calculated as oxides, as is usual for glasses and glass ceramics.

The invention also relates to a glass according to the invention containing nuclei for crystallization. By heat treatment of the glass according to the invention, the glass according to the invention with nuclei can first be produced, which in turn can be converted into the glass ceramic according to the invention by further heat treatment.

The invention further relates to a glass according to the invention and a glass ceramic according to the invention, which exhibit a whitish-blue fluorescence color in the CIE color space when excited with light having a wavelength of 380 to 430 nm, in particular 395 nm.

The invention also relates to a process for preparing the glass according to the invention or the glass ceramic according to the invention, in which the tin is used at least partially in divalent form and in particular as SnO.

In the preparation of the glasses and glass ceramics according to the invention, in particular a mixture of suitable starting materials, such as carbonates, oxides, phosphates and fluorides, is melted. In a preferred embodiment, the starting materials of the components of the glasses and glass ceramics according to the invention are melted at a temperature of 1400 to 1800° C., in particular 1450 to 1600° C. and particularly preferably about 1500° C. for, in particular, 20 min to 10 h. To achieve a particularly high homogeneity, the glass melt obtained is poured into water to form a glass granulate, and the granulate obtained is then remelted.

The melt can be poured into molds to produce blanks of the starting glass, so-called solid glass blanks or monolithic blanks.

It is also possible to add the melt to water again to produce a granulate. This granulate can then be pressed into a blank, a so-called powder compact, after grinding and, optionally, the addition of further components, such as colorants.

Finally, the starting glass can also be processed into a powder after granulation.

The glass, e.g. in the form of a solid glass blank, a powder compact or a powder, can then be heat treated to produce the glass with nuclei. This is also referred to as nucleation process. The invention is therefore also directed to a process for preparing the glass with nuclei, in which the glass is subjected to a heat treatment at a temperature of 450 to 600° C. and in particular 470 to 550° C. for a duration of in particular 5 to 120 min and preferably 10 to 60 min.

The glass with nuclei can then be used to form the glass ceramic according to the invention by heat treatment. The invention is therefore also directed to a process for preparing the glass ceramic according to the invention, in which the glass, in particular the glass with nuclei, is subjected to at least one heat treatment at a temperature of 700 to 950° C. for a duration of, in particular, 5 to 120 min and preferably 10 to 60 min.

The glass according to the invention and the glass with nuclei according to the invention are, preferably in the form of a powder or powder compact, subjected to the at least one heat treatment for producing the glass ceramic.

In a further preferred embodiment, the at least one heat treatment is carried out as part of a sintering-on process, in particular of a powder.

Thus, in a preferred embodiment, the invention relates to a process for the preparing the glass ceramic according to the invention, in which
(a) powder of the glass according to the invention, optionally after addition of further components, such as other glasses, glass ceramics and/or pressing aids, is pressed to a powder compact, and
(b) the powder compact is subjected to a heat treatment at a temperature of 700 to 950° C. for a duration of in particular 5 to 120 min.

In this process, a nucleation may optionally be performed prior to heat treatment in step (b).

Furthermore, the invention relates to the use of the glass according to the invention and the glass ceramic according to the invention with a high content of cerium and tin for adjusting the fluorescence of another glass and another glass ceramic. Therefore, a glass and a glass ceramic comprising the glass according to the invention or the glass ceramic according to the invention constitute another subject matter of the invention. In this context, a glass and a glass ceramic are particularly preferred which contain the glass according to the invention or the glass ceramic according to the invention containing cerium and tin in an amount of 0.1 to 60 wt.-%, in particular 1 to 58 wt.-%, preferably 5 to 56 wt.-%, particularly preferably 10 to 54 wt.-% and more preferably 15 to 52 wt.-%, based on the total amount of glass or glass ceramic and glass according to the invention or glass ceramic according to the invention.

The glass and the glass ceramic with a high content of cerium and tin according to the invention can be used, in particular, in combination with a variety of other glasses and/or glass ceramics, and the combinations can be used, in particular, as dental materials. Particularly preferably, the combinations may be in the form of sintering blanks. Examples of other glasses and glass ceramics for the production of combinations are disclosed in DE 43 14 817 A1 and corresponding U.S. Pat. No. 5,432,130 A, DE 44 23 793 C1 and corresponding U.S. Pat. No. 5,698,019 A, DE 44 23 794 C1 and corresponding U.S. Pat. No. 5,925,180 A, DE 44 28 839 A1 and corresponding U.S. Pat. No. 5,618,763 A, DE 196 47 739 A1, DE 197 25 552 A1, DE 100 31 431 A1, EP 0 827 941 A1, EP 0 916 625 A1, WO 00/34196 A2 and corresponding U.S. Pat. No. 6,455,451 B1, EP 1 505 041 A1 and corresponding U.S. Pat. No. 8,047,021 B2, EP 1 688 398 A1, EP 2 287 122 A1 and corresponding US 2011021336 A1, EP 2 377 831 A1 and corresponding U.S. Pat. No. 9,321,674 B2, EP 2 407 439 A1 and corresponding U.S. Pat. No. 9,321,674 B2, WO 2013/053863 A2 and corresponding U.S. Pat. No. 9,878,939 B2, WO 2013/053864 A2 and corresponding U.S. Pat. No. 9,776,912 B2, WO 2013/053865 A2 and corresponding U.S. Pat. No. 9,402,699 B2, WO 2013/053866 A2 and corresponding U.S. Pat. No. 9,695,082 B2, WO 2013/053867 A2 and corresponding U.S. Ser. No. 10/227,255 B2, WO 2013/053868 A2 and corresponding U.S. Pat. No. 9,403,714 B2, WO 2013/164256 A1 and corresponding U.S. Pat. No. 9,764,982 B2, WO 2014/170168 A1 and corresponding U.S. Ser. No. 10/376,343 B2, WO 2014/170170 A2 and corresponding U.S. Pat. No. 9,757,311 B2, WO 2015/067643 A1 and corresponding U.S. Pat. No. 9,688,567 B2, WO 2015/155038 A1 and corresponding U.S. Ser. No. 11/051,918 B2, WO 2015/173394 A1 and corresponding U.S. Ser. No. 11/091,388 B2, WO 2016/120146 A1 and corresponding U.S. Ser. No. 10/457,589 B2, WO 2017/032745 A1 and corresponding U.S. Ser. No. 11/325,858 B2, WO 2017/055010 A1 and corresponding U.S. Ser. No. 10/590,028 B2.

The US patents and/or US patent applications set forth in this paragraph above are incorporated by reference in their entirety. These glasses and glass ceramics belong to the silicate, borate, phosphate or aluminosilicate group. Preferred glasses and glass ceramics are of SiO₂—Al₂O₃—K₂O type (with cubic or tetragonal leucite crystals), SiO₂—B₂O₃—Na₂O type, alkali silicate type, alkali zinc silicate type, silico phosphate type and/or SiO₂—ZrO₂ type. Particularly preferred are lithium silicate glass ceramics and, in particular, glass ceramics containing lithium metasilicate or lithium disilicate as the main crystal phase and, optionally, further crystal phases such as lithium metasilicate, lithium disilicate, apatite, diopside, spodumene, petalite, eucryptite and/or wollastonite, and glass ceramics containing SiO₂, in particular in the form of low quartz solid solution and/or high quartz solid solution, as the main crystal phase. By mixing such glasses or glass ceramics with the glasses and/or glass ceramics with a high content of cerium and tin according to the invention, the fluorescence properties in particular can be adjusted in a desired manner.

The glass according to the invention and the glass ceramic according to the invention, in particular in the form of combinations, are present in particular in the form of powders, granules, pastes, aerosols or blanks in any shape and size, e.g. monolithic blanks, such as platelets, cuboids or cylinders, or powder compacts, in unsintered, partially sintered or densely sintered form. In these forms, they can be easily further processed, e.g. into dental restorations. However, they can also be in the form of dental restorations, such as inlays, onlays, crowns, partial crowns, bridges, veneers, facets or abutments, or as a coating of a dental restoration.

Dental restorations, such as inlays, onlays, crowns, partial crowns, bridges, veneers, facets or abutments, can be produced from the glass ceramics according to the invention and the glasses according to the invention, in particular in the form of combinations. The invention therefore relates to their use as dental materials and in particular to their use in the preparing of a dental restoration. It is preferred that the glass ceramic and the glass are given the shape of the desired dental restoration by pressing, sintering or machining.

The pressing is usually carried out under elevated pressure and temperature. It is preferred that the pressing is carried out at a temperature of 700 to 1150° C. and in particular 700 to 1000° C. It is further preferred that the pressing is carried out at a pressure of 10 to 30 bar. During pressing, the desired change in shape is achieved by viscous flow of the material used. The glass according to the invention and the glass with nuclei according to the invention, as well as preferably the glass ceramic according to the invention, can be used for the pressing. In particular, the glass and glass ceramic according to the invention can be used in the form of blanks of any shape and size, e.g. powder compacts in unsintered, partially sintered or densely sintered form.

Machining is usually carried out by material-removing processes and in particular by milling and/or grinding. It is particularly preferred that the machining is carried out as part of a CAD/CAM process. The glass according to the invention, the glass with nuclei according to the invention and the glass ceramic according to the invention can be used for the machining. In this context, the glasses and glass ceramics according to the invention can be used in particular in the form of blanks, e.g. unsintered, partially sintered or densely sintered powder compacts. Preferably, the glass ceramic according to the invention is used for machining. The glass ceramic according to the invention can also be used in a not yet fully crystallized form, which has been produced by heat treatment at a lower temperature. This offers the advantage of easier machining and thus the use of simpler apparatus for machining. After machining such a partially crystallized material, it is regularly subjected to further heat treatment to induce further crystallization.

The glass ceramics according to the invention and the glasses according to the invention, in particular in the form of combinations, are also suitable for coating ceramics, glass ceramics and metals, for example. By “coatings” which can be produced using the glasses according to the invention and the glass ceramics according to the invention, in particular in the form of combinations, is also meant, for example, glazes.

The invention is therefore also directed to the use of the glass according to the invention and the glass ceramic according to the invention, in particular in the form of combinations, for coating in particular ceramics, glass ceramics and metals. The coating preferably comprises applying glass according to the invention or glass ceramic according to the invention, in particular in the form of combinations, to a substrate material and subjecting it together with the substrate material to a heat treatment, preferably at a temperature of at least 600° C., in particular 600 to 1150° C. and particularly preferably 700 to 1000° C.

This can be done in particular by sintering-on and preferably by pressing-on. In the case of sintering-on, the glass ceramic and the glass are applied in the usual manner, e.g. as a powder, paste or aerosol, to the material to be coated, such as ceramic, glass ceramic or metal, and then sintered. In the preferred pressing-on process, glass ceramic according to the invention and glass according to the invention, e.g. in the form of powder compacts, are pressed-on at an elevated temperature of, for example 700 to 1150° C., and in particular 700 to 1000° C., and with the application of pressure, for example 10 to 30 bar. In particular, the processes described in EP 231 773 and the pressing furnace disclosed therein can be used for this purpose. Suitable commercial furnaces are the Programat type furnaces from Ivoclar Vivadent AG, Liechtenstein.

Due to the above-described properties of the glass ceramics according to the invention and the glasses according to the invention, they are particularly suitable for use in dentistry. It is therefore also an object of the invention to use the glass ceramic according to the invention and the glass according to the invention, in particular in the form of combinations, as a dental material and in particular for preparing a dental restoration or for coating a dental restoration, such as a crown, a bridge and an abutment.

Particularly preferred is the use for coating a dental restoration, wherein a substrate material, in particular a glass ceramic, a ceramic or a metal, is coated with glass according to the invention or glass ceramic according to the invention, in particular in the form of combinations. Particularly preferably, the dental restoration is selected from inlay, onlay, crown, partial crown, bridge, veneer, facet and abutment.

The use for coating dental restorations preferably comprises applying glass according to the invention or glass ceramic according to the invention, in particular in the form of a combination, to a substrate material and subjecting it together with the substrate material to a heat treatment, preferably at a temperature of at least 600° C., in particular 600 to 1150° C. and particularly preferably 700 to 1000° C. The application of the glass according to the invention or the glass ceramic according to the invention, in particular in the form of a combination, is carried out in the usual manner, for example as a powder, paste or aerosol.

The invention thus also relates to a process for preparing a dental restoration, in particular an inlay, onlay, crown, partial crown, bridge, veneer, facet or abutment, in which the glass ceramic or glass according to the invention, in particular in the form of combinations, is given the shape of the desired dental restoration by pressing, sintering or machining, in particular as part of a CAD/CAM process.

The invention also relates to a process for coating a dental restoration, in particular an inlay, onlay, crown, partial crown, bridge, veneer, facet or abutment, in which the glass according to the invention or the glass ceramic according to the invention, in particular in the form of a combination, is applied to a substrate material and is subjected together with the substrate material to a heat treatment, preferably at a temperature of at least 600° C., in particular 600 to 1150° C. and particularly preferably 700 to 1000° C. The application of the glass according to the invention and the glass ceramic according to the invention, in particular in the form of a combination, is carried out in the usual manner, for example as a powder, paste or aerosol. Preferably, the substrate material is a glass ceramic, a ceramic or a metal.

The invention is explained in more detail below by means of examples which do not limit it.

### Examples

### 1. Preparation of Fluorescent Glasses

Thirty glasses according to the invention with the compositions given in Table I were prepared. For this purpose, starting glasses with the compositions given in Table I were first melted from common raw materials at 1500° C. for 60 min. Glass frits were prepared by pouring the molten starting glasses into water.

In addition, two glasses were produced as comparative examples using a corresponding process. The compositions of these glasses are also given in Table I as Examples 31 and 32. In deviation from the process for the preparation of the glasses of Examples 1 to 30, the melting for the production of Example 31 was carried out at 1650° C. for 240 min.

The glass transition temperature T_{g} also given for the glasses according to the invention in Table I was determined by DSC (Differential Scanning Calorimetry).

The fluorescence properties of the glass frits were investigated. For this purpose, the glass frits were successively irradiated with a mercury vapor lamp (excitation wavelength 366 nm) and with a UV LED (excitation wavelength 395 nm) and examined for fluorescence with the naked eye in each case.

For the glass frits of examples 1 to 30, clear fluorescence could be perceived both upon excitation with the mercury vapor lamp and upon excitation with the UV LED.

The glass frit of Example 31 showed clearly perceptible fluorescence when irradiated with the mercury vapor lamp (excitation wavelength 366 nm). However, no fluorescence could be perceived upon excitation with the UV LED (excitation wavelength 395 nm). Examination of the glass frit of Example 32 showed that no fluorescence was perceptible either when irradiated with the mercury vapor lamp or when irradiated with the UV LED.

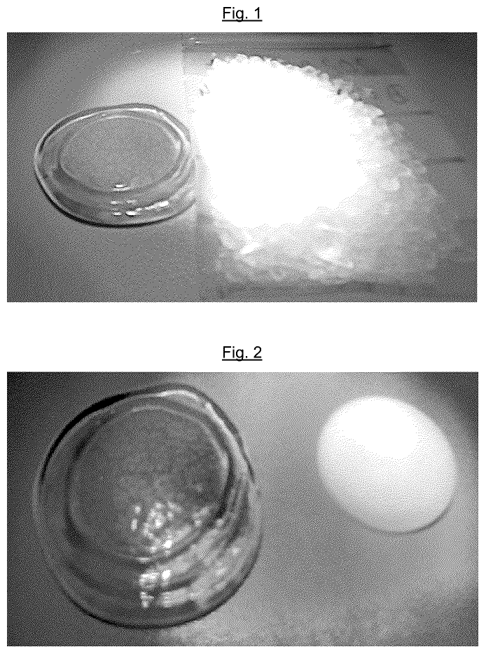

The advantageous fluorescence of the glass frits according to the invention is illustrated in FIG. 1. FIG. 1 shows on the right side of the photograph the fluorescent glass frit of example 3 when excited with the UV LED (excitation wavelength 395 nm). For comparison, a solid glass sheet was made from the glass frit of Example 31 by performing the procedure described for Example 5 in EP 3 696 149 A1 and corresponding U.S. Ser. No. 11/440,833 B2, which US patent is incorporated by reference in its entirety. The process involved re-melting the glass frit of Example 31 for 240 min at 1650° C. The melt obtained was then poured onto a copper block to produce a solid glass sheet. The solid glass sheet obtained in this way is shown on the left side of the photograph of FIG. 1 and shows no fluorescence.

TABLE I

| | Example | | | | | | | |
|---|---|---|---|---|---|---|---|---|
| | 1 | 2 | 3 | 4 | 5 | 6 | 7 | 8 |
| Composition | Wt.-% | Wt.-% | Wt.-% | Wt.-% | Wt.-% | Wt.-% | Wt.-% | Wt.-% |
| SiO₂ | 70.1 | 67.7 | 64.5 | 61.0 | 57.9 | 54.8 | 52.0 | 68.1 |
| CeO₂ | 4.6 | 4.5 | 8.7 | 11.3 | 13.6 | 15.8 | 17.9 | 6.0 |
| SnO | 3.6 | 7.0 | 6.8 | 8.8 | 10.7 | 12.4 | 14.0 | 4.7 |
| Li₂O | 14.6 | 14.0 | 13.4 | 12.7 | 12.0 | 11.4 | 10.8 | 14.2 |
| K₂O | 3.8 | 3.6 | 3.5 | 3.3 | 3.1 | 3.0 | 2.8 | 3.7 |
| Al₂O₃ | 3.3 | 3.2 | 3.1 | 2.9 | 2.7 | 2.6 | 2.5 | 3.3 |
| P₂O₅ | — | — | — | — | — | — | — | — |
| Tb₄O₇ | — | — | — | — | — | — | — | — |
| MgO | — | — | — | — | — | — | — | — |
| CaO | — | — | — | — | — | — | — | — |
| SrO | — | — | — | — | — | — | — | — |
| ZnO | — | — | — | — | — | — | — | — |
| ZrO₂ | — | — | — | — | — | — | — | — |
| Σ | 100.0 | 100.0 | 100.0 | 100.0 | 100.0 | 100.0 | 100.0 | 100.0 |
| Tg [° C.] | 470.4 | 479.4 | 492.2 | 501.4 | 517.2 | 537.8 | 562.2 | 475 |
| | Example | | | | | | | |
| | 9 | 10 | 11 | 12 | 13 | 14 | 15 | 16 |
| Composition | Wt.-% | Wt.-% | Wt.-% | Wt.-% | Wt.-% | Wt.-% | Wt.-% | Wt.-% |
| SiO₂ | 66.5 | 64.8 | 70.1 | 69.6 | 69.2 | 68.3 | 67.5 | 65.7 |
| CeO₂ | 5.9 | 5.8 | 4.6 | 4.6 | 4.5 | 4.5 | 4.5 | 4.4 |
| SnO | 4.6 | 4.6 | 3.6 | 3.6 | 3.6 | 3.5 | 3.5 | 3.5 |
| Li₂O | 13.8 | 13.4 | 14.5 | 14.4 | 14.4 | 14.2 | 14.0 | 13.6 |
| K₂O | 3.6 | 3.5 | 3.8 | 3.8 | 3.7 | 3.7 | 3.6 | 3.6 |
| Al₂O₃ | 3.2 | 3.1 | 3.3 | 3.3 | 3.3 | 3.2 | 3.2 | 3.1 |
| P₂O₅ | 2.4 | 4.8 | — | — | — | — | 3.7 | 6.1 |
| Tb₄O₇ | — | — | 0.1 | 0.7 | 1.3 | 2.6 | — | — |
| MgO | — | — | — | — | — | — | — | — |
| CaO | — | — | — | — | — | — | — | — |
| SrO | — | — | — | — | — | — | — | — |
| ZnO | — | — | — | — | — | — | — | — |
| ZrO₂ | — | — | — | — | — | — | — | — |
| Σ | 100.0 | 100.0 | 100.0 | 100.0 | 100.0 | 100.0 | 100.0 | 100.0 |
| Tg [° C.] | 480 | 483.3 | 473.7 | 471.4 | 472.2 | 478.7 | 477.7 | 482.1 |
| | Example | | | | | | | |
| | 17 | 18 | 19 | 20 | 21 | 22 | 23 | 24 |
| Composition | Wt.-% | Wt.-% | Wt.-% | Wt.-% | Wt.-% | Wt.-% | Wt.-% | Wt.-% |
| SiO₂ | 62.5 | 62.0 | 58.8 | 57.0 | 55.7 | 62.0 | 66.5 | 67.8 |
| CeO₂ | 8.6 | 8.5 | 9.1 | 9.0 | 8.8 | 8.9 | 8.6 | 8.5 |
| SnO | 6.7 | 6.7 | 7.1 | 7.0 | 6.9 | 7.0 | 6.7 | 6.7 |
| Li₂O | 13.0 | 12.9 | 18.2 | 17.8 | 17.3 | 15.4 | 11.8 | 10.6 |
| K₂O | 3.4 | 3.4 | 3.6 | 3.6 | 3.4 | 3.6 | 3.4 | 3.4 |
| Al₂O₃ | 3.0 | 3.0 | 3.2 | 3.1 | 3.0 | 3.1 | 3.0 | 3.0 |
| P₂O₅ | 2.8 | 3.5 | — | 2.5 | 4.9 | — | — | — |
| Tb₄O₇ | — | — | — | — | — | — | — | — |
| MgO | — | — | — | — | — | — | — | — |
| CaO | — | — | — | — | — | — | — | — |
| SrO | — | — | — | — | — | — | — | — |
| ZnO | — | — | — | — | — | — | — | — |
| ZrO₂ | — | — | — | — | — | — | — | — |
| Σ | 100.0 | 100.0 | 100.0 | 100.0 | 100.0 | 100.0 | 100.0 | 100.0 |
| Tg [° C.] | 497.1 | 493.1 | 470.4 | 469.6 | 472.3 | 480.9 | 494.2 | 506.2 |
| | Example | | | | | | | |
| | 25 | 26 | 27 | 28 | 29 | 30 | 31* | 32* |
| Composition | Wt.-% | Wt.-% | Wt.-% | Wt.-% | Wt.-% | Wt.-% | Wt.-% | Wt.-% |
| SiO₂ | 67.1 | 60.1 | 66.8 | 61.8 | 65.9 | 60.9 | 63.7 | 73.8 |
| CeO₂ | 8.9 | 8.5 | 8.9 | 8.6 | 4.3 | 8.3 | 7.3 | — |
| SnO | 6.9 | 6.7 | 6.9 | 6.7 | 3.4 | 6.5 | 2.8 | — |
| Li₂O | 13.9 | 12.5 | 13.9 | 12.8 | 10.9 | 10.1 | 15.8 | 15.3 |
| K₂O | — | 9.3 | 3.6 | 3.3 | 2.3 | 2.1 | 5.0 | 4.0 |
| Al₂O₃ | 3.2 | 2.9 | — | 6.8 | 2.5 | 2.3 | 5.4 | 3.5 |
| P₂O₅ | — | — | — | — | 3.5 | 3.2 | — | 3.4 |
| Tb₄O₇ | — | — | — | — | — | — | — | — |
| MgO | — | — | — | — | 1.0 | 0.9 | — | — |
| CaO | — | — | — | — | 1.4 | 1.3 | — | — |
| SrO | — | — | — | — | 2.5 | 2.3 | — | — |
| ZnO | — | — | — | — | 1.3 | 1.2 | — | — |
| ZrO₂ | — | — | — | — | 1.0 | 0.9 | — | — |
| Σ | 100.0 | 100.0 | 100.0 | 100.0 | 100.0 | 100.0 | 100.0 | 100.0 |
| Tg [° C.] | 497.6 | 480.8 | 493.6 | 492.1 | 480.7 | 494.8 | — | — |

*Comparison

### 2. Use of the Fluorescent Glasses as a Mixing Component

The glass frits of Examples 3 and 32 were ground to a particle size of 45 μm in a zirconia mill. Subsequently, the ground glass frit of Example 3 was added in different amounts (20, 33 and 50 wt.-% based on the mixture) as a mixing component to the non-fluorescent ground glass frit of Example 32.

The different powder mixtures were then pressed into powder compacts by means of a hydraulic press at 15 bar for 10 s and sintered at 920° C. for 10 min.

After sintering, the fluorescence properties of the sintered powder compacts were investigated with a mercury vapor lamp (excitation wavelength 366 nm) and with a UV LED (excitation wavelength 395 nm). The sintered powder blanks showed clearly perceptible fluorescence both when irradiated with the mercury vapor lamp and with the UV LED. It was found that intense fluorescence can be obtained by using a high proportion of fluorescent compound component.

### 3. Preparation of Sintered Glass Ceramic Blanks

The glass frits of examples 9, 10, 15 to 18, 20, 21, 29 and 30 were ground to a particle size of 45 μm in a zirconium oxide mill. The glass powders obtained were pressed into blanks by means of a hydraulic press at 15 bar for 10 s and sintered in a sintering furnace at a temperature T_{Sinter} and a holding time of t_{Sinter} to form dense glass ceramic blanks. The crystal phases of the glass ceramic blanks were determined by X-ray diffraction (XRD) analysis. The determination of the masses of the crystal phases can be done by the Rietveld method. A suitable method for this is described, for example, in the dissertation by M. Dittmer “Glasses and glass ceramics in the system MgO—Al₂O₃—SiO₂ with ZrO₂ as nucleating agent”, University of Jena 2011.

The sintering conditions T_{Sinter} and t_{Sinter} used for the production of the individual glass ceramic blanks and the crystal phases determined are given in Table II. The term “main crystal phase” refers to the crystal phase which has the highest mass proportion of all crystal phases present in the glass ceramic.

The fluorescence of the obtained glass ceramic bodies was determined under a mercury vapor lamp (excitation wavelength 366 nm) and a UV LED (excitation wavelength 395 nm). All sintered glass ceramic bodies showed clearly perceptible fluorescence when irradiated with the mercury vapor lamp and also when irradiated with the UV LED.

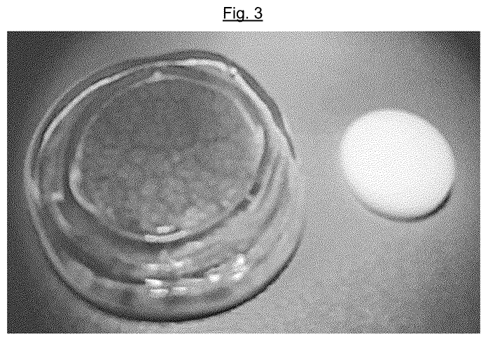

The advantageous fluorescence of the glass ceramic blanks according to the invention is illustrated by FIGS. 2 and 3. FIG. 2 shows, on the right side of the photograph, the fluorescent glass ceramic blank of Example 15 when excited with the UV LED (excitation wavelength 395 nm). In FIG. 3, the fluorescent glass ceramic blank of Example 17 is shown on the right side of the photograph when excited with the UV LED (excitation wavelength 395 nm). In FIGS. 2 and 3, a non-fluorescent solid glass sheet is shown on the left side of each photograph, which was produced by the same process as the solid glass sheet shown in FIG. 1.

TABLE II

| | Ground Glass frit from Example | | | | | | | | | |
|---|---|---|---|---|---|---|---|---|---|---|
| | 9 | 10 | 15 | 16 | 17 | 18 | 20 | 21 | 29 | 30 |
| T_{Sinter} [° C.] | 900 | 900 | 920 | 920 | 920 | 920 | 950 | 950 | 850 | 850 |
| t_{Sinter} [min] | 10 | 10 | 10 | 10 | 10 | 10 | 10 | 10 | 10 | 10 |
| Main | Li₂Si₂O₅ | Li₂S₂O₅ | Li₂S₂O₅ | Li₂Si₂O₅ | Li₂Si₂O₅ | Li₂Si₂O₅ | Li₂SiO₃ | Li₂SiO₃ | Li₂Si₂O₅ | Li₂Si₂O₅ |
| crystal | | | | | | | | | | |
| phase | | | | | | | | | | |
| Other | SnO₂ | SnO₂ | Li₃PO₄ | Li₃PO₄ | SnO₂ | SnO₂ | SnO₂ | SnO₂ | Quartz | Quartz |
| crystal | Li₂SiO₃ | Li₃PO₄ | | | Li₂SiO₃ | Li₂SiO₃ | Li₃PO₄ | Li₃PO₄ | solid | solid |
| phases | Li₃PO₄ | | | | Li₃PO₄ | Li₃PO₄ | | | solution | solution |
| | | | | | | | | | Cristo- | Cristo- |
| | | | | | | | | | balite | balite |
| | | | | | | | | | Li₃PO₄ | Li₃PO₄ |

1. Glass and glass ceramic containing cerium and tin, which comprise the following components:

| Component | Wt. % |
|---|---|
| SiO₂ | 48.0 to 75.0 |
| Li₂O | 8.0 to 20.5 |
| Cerium, calculated as CeO₂ | 4.0 to 20.0 |
| Tin, calculated as SnO | 3.1 to 15.7. |

2. Glass and glass ceramic according to claim 1, which comprise 50.0 to 72.0 wt. % SiO₂.

3. Glass and glass ceramic according to claim 1, which comprise 9.0 to 19.0 wt. % Li₂O.

4. Glass and glass ceramic according to claim 1, which comprise 4.3 to 19.0 wt. % cerium, calculated as CeO₂.

5. Glass and glass ceramic according to claim 1, which comprise 3.4 to 14.9 wt. % tin, calculated as SnO.

6. Glass and glass ceramic according to claim 1, wherein the molar ratio of cerium, calculated as CeO₂, to tin, calculated as SnO, is in the range of 1.5:1 to 1:1.5.

7. Glass and glass ceramic according to claim 1, which comprise at least one of the following components in the amounts indicated:

| Component | Wt.-% |
|---|---|
| SiO₂ | 48.0 to 75.0 |
| Li₂O | 8.0 to 20.5 |
| Cerium, calculated as CeO₂ | 4.0 to 20.0 |
| Tin, calculated as SnO | 3.1 to 15.7 |
| Me^{I}₂O | 0 to 11.5 |
| Me^{II}O | 0 to 11.0 |
| Me^{III}₂O₃ | 0 to 8.0 |
| Me^{IV}O₂ | 0 to 2.0 |
| Me^{V}₂O₅ | 0 to 8.0 |
| Terbium, calculated as Tb₄O₇ | 0 to 3.5 |
| Fluorine | 0 to 5.0, |

wherein
Me^{I}₂O is selected from Na₂O, K₂O, Rb₂O and/or CsO₂,
Me^{II}O is selected from MgO, CaO, SrO, BaO and/or ZnO,
Me^{III}₂O₃ is selected from B₂O₃, Y₂O₃, La₂O₃, Ga₂O₃ and/or In₂O₃,
Me^{IV}O₂ is selected from ZrO₂, TiO₂ and/or GeO₂,
Me^{V}₂O₅ is selected from P₂O₅, V₂O₅, Ta₂O₅ and/or Nb₂O₅.

8. Glass and glass ceramic according to claim 1, which comprise at least one of the following components in the amounts indicated:

| Component | Wt.-% |
|---|---|
| SiO₂ | 48.0 to 75.0 |
| Li₂O | 8.0 to 20.5 |
| Cerium, calculated as CeO₂ | 4.0 to 20.0 |
| Tin, calculated as SnO | 3.1 to 15.7 |
| K₂O | 0 to 11.0 |
| Al₂O₃ | 0 to 8.0 |
| MgO | 0 to 2.0 |
| CaO | 0 to 2.5 |
| SrO | 0 to 4.0 |
| ZnO | 0 to 2.2 |
| Terbium, calculated as Tb₄O₇ | 0 to 3.5 |
| P₂O₅ | 0 to 8.0 |
| ZrO₂ | 0 to 2.0. |

9. Glass according to claim 1, which comprises nuclei for crystallization.

10. Glass and glass ceramic, which comprise the glass or the glass ceramic containing cerium and tin according to claim 1, in an amount of 0.1 to 60 wt. %.

11. Glass and glass ceramic according to claim 1, wherein the glass and glass ceramic are in the form of a powder, a granulate, a paste, an aerosol, a blank, a dental restoration, or a coating of a dental restoration.

12. Process for preparing the glass and the glass ceramic according to claim 1, wherein the tin is used at least partially in divalent form.

13. Process according to claim 12, wherein the starting materials of the components of the glass or the glass ceramic are melted at a temperature of 1400° C. to 1800° C.

14. Process according to claim 13, wherein the starting materials are melted for 20 min to 10 h.

15. Process of using the glass or glass ceramic according to claim 1, as a mixing component for adjusting the fluorescence of a glass or glass ceramic.

16. Process of using the glass or glass ceramic according to claim 1 as a dental material.

17. Process of claim 16, wherein the dental material comprises a dental restoration or a coating on a dental restoration.

18. Process for preparing a dental restoration comprising an inlay, onlay, crown, partial crown, bridge, veneer, facet or abutment, wherein the glass or the glass ceramic according to claim 1 is given the shape of the desired dental restoration by pressing, sintering or machining.

19. Process according to claim 18, wherein machining comprises a CAD/CAM process.
